(19) United States
(12) Patent Application Publication
(10) Pub. No.: US 2024/0076805 A1
(43) Pub. Date: Mar. 7, 2024

(54) CAM-DRIVEN WIRE MESH-TYPE ELECTROSPINNING APPARATUS AND USE METHOD THEREFOR

(71) Applicant: Guangdong University of Petrochemical Technology, Maoming (CN)

(72) Inventors: Xiaoqing CHEN, Maoming (CN); Jiahao LIANG, Maoming (CN); Wenyu XIE, Maoming (CN); Min HUANG, Maoming (CN); Yebin CAI, Maoming (CN); Changgang LI, Maoming (CN); Dehao LI, Maoming (CN)

(73) Assignee: Guangdong University of Petrochemical Technology, Maoming (CN)

(21) Appl. No.: 18/233,917

(22) Filed: Aug. 15, 2023

(30) Foreign Application Priority Data
Sep. 5, 2022 (CN) 202211076277.3

(51) Int. Cl. D01D 5/00

(52) U.S. Cl. CPC D01D 5/0069; D01D 5/0076

(57) ABSTRACT

A cam-driven wire mesh-type electrospinning apparatus and a use method therefor are provided. The cam-driven wire mesh-type electrospinning apparatus includes the following components: a high-voltage (HV) power supply unit, a wire mesh-type spinneret, a fiber receiving device, a cam unit, and a solution supply unit. The positions and connection relationships of all the components are as follows: any end of the wire mesh-type spinneret is connected to the HV power supply unit, and the other end of the wire mesh-type spinneret is connected to the cam unit; the wire mesh-type spinneret is installed on the solution supply unit; and the fiber receiving device is positioned right above the wire mesh-type spinneret. The cam-driven wire mesh-type electrospinning apparatus may induce a solution to be uniformly distributed on a wire mesh plane, and adjust the density of jet flow and the distribution position of the jet flow.

### CROSS REFERENCE TO THE RELATED APPLICATIONS

This application is based upon and claims priority to Chinese Patent Application No. 202211076277.3, filed on Sep. 5, 2022, the entire contents of which are incorporated herein by reference.

### TECHNICAL FIELD

The present invention relates to the technical field of electrospinning, and in particular, to a cam-driven wire mesh-type electrospinning apparatus and a use method therefor.

### BACKGROUND

The polymer nanofiber prepared by electrospinning technology has excellent characteristics of small diameter, high length-diameter ratio, large specific surface area, adjustable size and shape, and the like, and thus has huge application advantages and application potentials in the fields of individual protection, energy storage, environmental protection, biomedicine, and the like. At present, the electrospinning technology is generally recognized as a nanofiber production technology with the most industrialized application value. Compared with the technologies such as template synthesis and self-assembly, the electrospinning technology has the advantages of simple apparatus, convenient operation, wide application, economical and effective continuous preparation of long fiber, and the like.

The electrospinning technology is a process that a solution or a melt forms a Taylor cone under a high-voltage electrostatic field, when an electric field force is strong enough, liquid drops are stretched and thinned after overcoming surface tension to generate jet flow, and the jet flow is subjected to splitting, rotary whip, solvent volatilization, and solidification and deposition on a receiving plate to obtain fiber. The conventional needle-type electrospinning has a lower production efficiency, and the needles are easy to be blocked and thus difficult to clean. When the multi-needle arrangement is used for large-scale production of nanofiber, the problem of electric field interference between needles is prone to occur.

The needleless electrospinning technology based on a free liquid level is one of the ways for realizing the mass production of the nanofiber. Meanwhile, the needleless electrospinning technology is concerned by the advantages that the needle head can be skillfully prevented from being blocked and the electric field is prevented from being interfered by the design of the spinneret. At present, researchers at home and abroad propose needleless electrospinning apparatuses such as bubble electrospinning, groove-type electrospinning, and zigzag-type electrospinning for producing nanofiber. Chinese Patent No. 201510650659.6 discloses a needleless electrospinning apparatus with a porous flexible pipe, where a hydraulic apparatus is used to feed, a compound flexible pipe combining a porous elasticity pipe and a snakeskin metal hose is used as a jet flow sprayer. This apparatus has solved the problem of easy blocking of the conventional needles, however, the small holes on the flexible pipe are easy to bounce, consequently, the stability of the direction of the solution jet flow is poor, and the control on a shape and a diameter of the fiber also has a specific limitation. Chinese Patent No. 201210177134.1 discloses a bubble electrospinning apparatus, which further achieves the effect of spinning by providing an air jet tube in a solution reservoir and forming a large quantity of bubbles on a surface of a solution by the action of the air jet. However, the bubbles are not uniform in size when broken under the action of electric field force, the surface self-organization forms Taylor cones and the distribution position of jet flow is difficult to control, the fiber diameter distribution is wide, and the required spinning voltage is high.

Therefore, how to provide an electrospinning apparatus that can effectively adjust the distribution density of a Taylor cone and jet flow and further control the forming stability and uniformity of fiber becomes a technical issue that urgently needs to be addressed by those skilled in the art.

### SUMMARY

In view of this, the present invention provides a cam-driven wire mesh-type electrospinning apparatus and a use method therefor, and aims to solve the technical issue of large spinning operation voltage, difficult adjustment of jet flow density distribution, large fiber diameter, poor uniformity, and the like in the existing large-scale electrospinning technology.

In order to achieve the above objective, the present invention uses the following technical solutions.

A cam-driven wire mesh-type electrospinning apparatus includes the following components: a high-voltage (HV) power supply unit, a wire mesh-type spinneret, a fiber receiving device, a cam unit, and a solution supply unit;
the positions and connection relationships of all the components are as follows: any end of the wire mesh-type spinneret is connected to the HV power supply unit, and the other end of the wire mesh-type spinneret is connected to the cam unit; the wire mesh-type spinneret is installed on the solution supply unit; the fiber receiving device is positioned right above the wire mesh-type spinneret.

Further, the wire mesh-type spinneret is formed by combining a plurality of metal wire arrays, and a quantity of the metal wires is 2-16;
the wire mesh-type spinneret is one of a rectangular wire mesh-type spinneret, a rectangular-welding ball wire mesh-type spinneret, and a round-welding ball wire mesh-type spinneret, wherein metal wires in the rectangular-welding ball wire mesh-type spinneret and the round-welding ball wire mesh-type spinneret include metal balls, the metal wire is made of one or more of copper, aluminum, and iron, and a diameter of the metal wire is 1-10 mm; a roughness Ra of the metal wire is 0.2-1.6; the metal ball is made of low-carbon steel metal, and a diameter of the metal ball is 1-5 mm; and
an area of the wire mesh-type spinneret is 10-10000 cm².

Further, the cam unit includes a cam push rod and a cam; the cam push rod and the cam are made of non-conductive plastics independently; a cross section of the cam push rod is rectangular, wherein a length of a short side is 2-10 mm, and a length of a long side is 10-100 mm; and the cam is a disc cam.

Further, the HV power supply unit includes a high-voltage electrostatic generator; the fiber receiving device includes a receiving electrode plate, receiving rollers, non-woven fabric, and a motor, wherein the non-woven fabric is flatly laid and wound on the receiving rollers, the receiving electrode plate is positioned between upper non-woven fabric and lower non-woven fabric, two receiving rollers are provided, one end of one receiving roller is connected to the motor, and the other end of the receiving roller is connected to a grounding electrode; and the solution supply unit includes a solution storage tank, a peristaltic pump, and a solution supply apparatus.

Further, the solution storage tank is made of polytetrafluoroethylene;
the receiving electrode plate is made of a conductive metal, and the receiving roller is made of a non-conductive insulating material; and
a diameter of the receiving roller is 20-200 mm.

The present invention provides a use method for the cam-driven wire mesh-type electrospinning apparatus, which includes the following steps:
S1: adjusting a spinning distance between the wire mesh-type spinneret and the fiber receiving device, and adjusting a rotating speed of the fiber receiving device;
S2: filling a spinning solution into the solution supply unit;
S3: starting the cam unit to make the wire mesh-type spinneret reciprocate up and down for a regular motion; and
S4: starting the HV power supply unit, and adjusting voltage to obtain electrospinning nanofiber.

Further, in the step S1, the spinning distance is 10-15 cm, and the rotating speed of the fiber receiving device is 100-1000 r/min.

Further, in the step S2, the spinning solution is an aqueous solution of polyvinyl alcohol, and a mass fraction of the aqueous solution of polyvinyl alcohol is 8-12%.

Further, in the step S3, the regular motion is one of a constant velocity motion, a constant acceleration motion, a constant deceleration motion, and a simple harmonic motion.

Further, in the step S4, the voltage of the HV power supply unit is −2 to 60 kV.

It can be known from the technical solutions that, compared with the conventional technology, the present invention has the following beneficial effects.
1. The cam-driven wire mesh-type spinning spinneret used in the present invention is driven by a cam motion mechanism to perform regular up-and-down reciprocating motion, a duration of the spinneret immersed in a spinning solution of the solution storage tank, an ascending and descending speed and acceleration as well as a residence duration of the spinneret moving to a top can be adjusted, and the stability and the yield of spinning forming are further controlled;
2. The wire mesh-type spinning spinneret used in the present invention induces a solution to be uniformly distributed on a wire mesh plane, and may adjust a density of a jet flow and a distribution position of the jet flow, so that a diameter fineness and a diameter distribution uniformity of nanofiber are improved;
3. Compared with the conventional spinning technology, the present invention improves the fiber production efficiency per unit length and unit time, achieves stable, continuous and uniform preparation of nanofiber, and can be produced in large-scale.

### BRIEF DESCRIPTION OF THE DRAWINGS

FIG. 1 is a schematic diagram of a cam-driven wire mesh-type electrospinning apparatus according to Embodiments 1-3 of the present invention, where reference numerals are as follows: 1: solution storage tank, 2: high-voltage electrostatic generator, 3: wire mesh-type spinneret, 4: motor, 5: non-woven fabric, 6: receiving electrode plate, 7: receiving roller, 8: cam push rod, 9: cam, 10: peristaltic pump, and 11: solution supply apparatus;

FIGS. 2A-2C are schematic diagrams of wire mesh-type spinnerets in different forms, where FIG. 2A is a rectangular wire mesh-type spinneret, FIG. 2B is a rectangular-welded ball wire mesh-type spinneret, FIG. 2C is a round-welded ball wire mesh-type spinneret, and 12 represents metal ball; and

FIG. 3 is a schematic diagram of a motion law of a cam.

### DETAILED DESCRIPTION OF THE EMBODIMENTS

The present invention provides a cam-driven wire mesh-type electrospinning apparatus, comprising the following components: an HV power supply unit, a wire mesh-type spinneret, a fiber receiving device, a cam unit, and a solution supply unit;
the positions and connection relationships of all the components are as follows: any end of the wire mesh-type spinneret is connected to the HV power supply unit, and the other end of the wire mesh-type spinneret is connected to the cam unit; the wire mesh-type spinneret is installed on the solution supply unit; the fiber receiving device is positioned right above the wire mesh-type spinneret.

In the present invention, the wire mesh-type spinneret is formed by combining a plurality of metal wire arrays, and a quantity of the metal wires is 2-16, preferably 4-15, and further preferably 6-12;
the wire mesh-type spinneret is one of a rectangular wire mesh-type spinneret, a rectangular-welding ball wire mesh-type spinneret, and a round-welding ball wire mesh-type spinneret, preferably a rectangular wire mesh-type spinneret or a rectangular-welding ball wire mesh-type spinneret, and further preferably a rectangular-welding ball wire mesh-type spinneret; the metal wires in the rectangular-welding ball wire mesh-type spinneret and the round-welding ball wire mesh-type spinneret comprise metal balls, and the metal wire is made of one or more of copper, aluminum, and iron, preferably copper, aluminum, iron, and an alloy thereof, and further preferably copper, aluminum, iron, copper-aluminum alloy, copper-iron alloy, or aluminum-iron alloy; the diameter of the metal wire is 1-10 mm, preferably 2-8 mm, and further preferably 4-6 mm; the roughness Ra of the metal wire is 0.2-1.6, preferably 0.4-1.2, and further preferably 0.6-1.0; the metal ball is made of low-carbon steel metal, preferably Q235 steel or No. 20 steel; the diameter of the metal ball is 1-5 mm, preferably 2-4 mm, and further preferably 3 mm;
the area of the wire mesh-type spinneret is 10-10000 cm², preferably 100-9000 cm², and further preferably 300-8000 cm².

In the present invention, the wire mesh-type spinneret has a function of performing regular up-and-down reciprocating motion under the driving of the cam unit. After the wire mesh-type spinneret repeatedly dips solution in the solution storage tank, a large quantity of Taylor cones are formed on the surface of the solution storage tank and then stretched and refined into a large quantity of fiber jet flow.

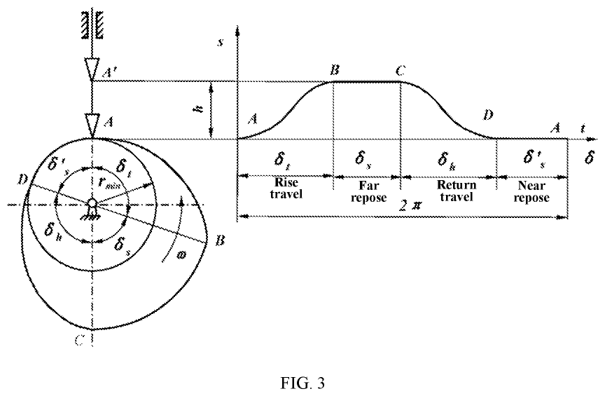

In the present invention, the cam unit comprises a cam push rod and a cam, wherein the cam provides a proper cam profile and geometry for the motion law of the wire mesh-type spinneret (as shown in FIG. 3); the cam push rod and the cam are made of non-conductive plastics independently, preferably polyoxymethylene or polytetrafluoroethylene, and further preferably polytetrafluoroethylene; the cross section of the cam push rod is rectangular, wherein the length of the short side is 2-10 mm, preferably 4-8 mm, and further preferably 5-6 mm; the length of the long side is 10-100 mm, preferably 20-80 mm, and further preferably 40-60 mm; and the cam is a disc cam.

In the present invention, the HV power supply unit comprises a high-voltage electrostatic generator; the fiber receiving device comprises a receiving electrode plate, receiving rollers, non-woven fabric, and a motor, wherein the non-woven fabric is flatly laid and wound on the receiving rollers, the receiving electrode plate is positioned between upper non-woven fabric and lower non-woven fabric, two receiving rollers are provided, one end of one receiving roller is connected to the motor, and the other end of the receiving roller is connected to a grounding electrode; and the solution supply unit comprises a solution storage tank, a peristaltic pump, and a solution supply apparatus.

In the present invention, the fiber receiving device is used to receive the electrospinning nanofiber obtained by fiber jet flow generated by the wire mesh-type spinneret through rotary whip, solvent volatilization, and solidification and deposition.

In the present invention, the solution storage tank is made of polytetrafluoroethylene;
the receiving electrode plate is made of a conductive metal, preferably copper, aluminum, iron, and an alloy thereof, and further preferably copper, aluminum, iron, copper-aluminum alloy, copper-iron alloy, or aluminum-iron alloy; the receiving roller is made of a non-conductive insulating material, preferably PTFE; and
the diameter of the receiving roller is 20-200 mm, preferably 40-180 mm, and further preferably 60-120 mm.

The present invention provides a use method for the cam-driven wire mesh-type electrospinning apparatus, which comprises the following steps:
S1: adjusting a spinning distance between the wire mesh-type spinneret and the fiber receiving device, and adjusting a rotating speed of the fiber receiving device;
S2: filling a spinning solution into the solution supply unit;
S3: starting the cam unit to make the wire mesh-type spinneret reciprocate up and down for a regular motion; and
S4: starting the HV power supply unit, and adjusting voltage to obtain electrospinning nanofiber.

In the present invention, in the step S1, the spinning distance is 10-15 cm, preferably 11-14 cm, and further preferably 12-13 cm; and the rotating speed of the fiber receiving device is 100-1000 r/min, preferably 200-800 r/min, and further preferably 400-600 r/min.

In the present invention, in the step S2, the spinning solution is an aqueous solution of polyvinyl alcohol, and a mass fraction of the aqueous solution of polyvinyl alcohol is 8-12%, preferably 9-11%, and further preferably 10%.

In the present invention, in the step S3, the regular motion is one of a constant velocity motion, a constant acceleration motion, a constant deceleration motion, and a simple harmonic motion, preferably a constant velocity motion, a constant acceleration motion, or a constant deceleration motion, and further preferably a constant velocity motion.

In the present invention, in the step S4, the voltage of the HV power supply unit is −2 to 60 kV, preferably 10-50 kV, and further preferably 20-40 kV.

The technical solutions in the embodiments of the present invention will be clearly and completely described below. Apparently, the described embodiments are merely a part, rather than all of the embodiments of the present invention. Based on the embodiments of the present invention, all other embodiments obtained by those of ordinary skill in the art without creative effort fall within the protection scope of the present invention.

### Embodiment 1

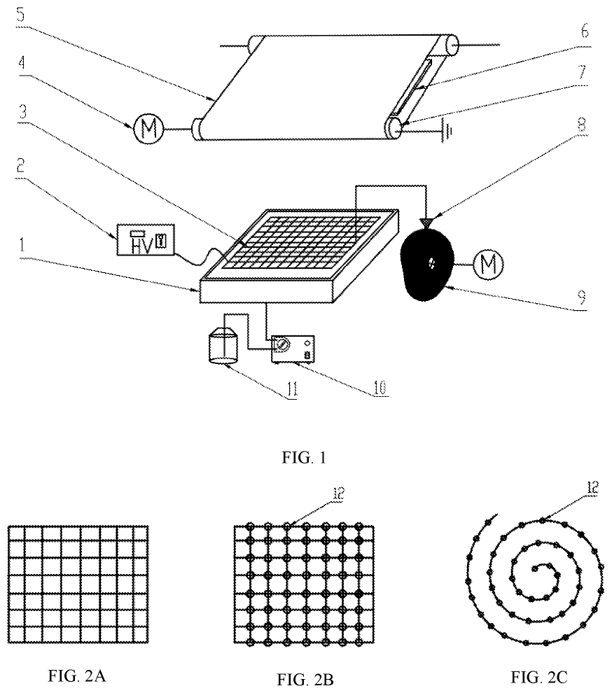

The spinning solution used in this embodiment is an aqueous solution of polyvinyl alcohol with a mass percentage of 10%; and the cam-driven wire mesh-type electrospinning apparatus used in this embodiment is shown in FIG. 1, where the wire mesh-type spinneret is a rectangular-welded ball wire mesh-type spinneret. A specific use method is as follows:
adjusting a spinning distance between the wire mesh-type spinneret and the receiving electrode plate to be 12 cm, and adjusting a motor to enable a rotating speed of the receiving roller to reach 200 r/min; putting the spinning solution into a solution supply apparatus, starting a peristaltic pump to uniformly input the spinning solution in the solution supply apparatus into a solution storage tank at a speed of 10 mL/min; starting a cam motion mechanism to enable the wire mesh-type spinneret to reciprocate up and down at a constant speed of 2 cm/s; and opening the high-voltage electrostatic generator, adjusting the voltage to 30 kV, and forming a strong high-voltage electrostatic field between the wire mesh-type spinneret and the receiving electrode plate; where the wire mesh-type spinneret performs up-and-down reciprocating motion and repeatedly dips the spinning solution in the solution storage tank under the push of the cam mechanism, after the spinneret leaves the liquid level, the solution can form uniform liquid drops along each metal wire on the whole wire mesh plane due to the action of surface tension, when the metal wire moves to a specific height, the solution attached on the wire is stretched to form a Taylor cone so as to form a large quantity of fiber jet flow under the stretching action of a high-voltage electrostatic field, and the fiber jet flow is subjected to rotary whip, solvent volatilization, and solidification and deposition on the non-woven fabric under the action of electric field force to obtain the electrospinning nanofiber.

### Embodiment 2

The spinning solution used in this embodiment is an aqueous solution of polyvinyl alcohol with a mass percentage of 11%; and the cam-driven wire mesh-type electrospinning apparatus used in this embodiment is shown in FIG. 1, where the wire mesh-type spinneret is a rectangular-welding ball wire mesh-type spinneret. A specific use method is as follows:
adjusting a spinning distance between the wire mesh-type spinneret and the receiving electrode plate to be 10 cm, and adjusting a motor to enable a rotating speed of the receiving roller to reach 180 r/min; putting the spinning solution into a solution supply apparatus, starting a peristaltic pump to uniformly input the spinning solution in the solution supply apparatus into a solution storage tank at a speed of 10 mL/min; starting a cam motion mechanism to enable the wire mesh-type spinneret to reciprocate up and down at a constant speed of 3 cm/s; and opening the high-voltage electrostatic generator, adjusting the voltage to 40 kV, and forming a strong high-voltage electrostatic field between the wire mesh-type spinneret and the receiving electrode plate; where the wire mesh-type spinneret performs up-and-down reciprocating motion and repeatedly dips the spinning solution in the solution storage tank under the push of the cam mechanism, after the spinneret leaves the liquid level, the solution can form uniform liquid drops along each metal wire on the whole wire mesh plane due to the action of surface tension, when the metal wire moves to a specific height, the solution attached on the wire is stretched to form a Taylor cone so as to form a large quantity of fiber jet flow under the stretching action of a high-voltage electrostatic field, and the fiber jet flow is subjected to rotary whip, solvent volatilization, and solidification and deposition on the non-woven fabric under the action of electric field force to obtain the electrospinning nanofiber.

### Embodiment 3

The spinning solution used in this embodiment is an aqueous solution of polyvinyl alcohol with a mass percentage of 12%; and the cam-driven wire mesh-type electrospinning apparatus used in this embodiment is shown in FIG. 1, where the wire mesh-type spinneret is a round-welding ball wire mesh-type spinneret. A specific use method is as follows:
adjusting a spinning distance between the wire mesh-type spinneret and the receiving electrode plate to be 12 cm, and adjusting a motor to enable a rotating speed of the receiving roller to reach 300 r/min; putting the spinning solution into a solution supply apparatus, starting a peristaltic pump to uniformly input the spinning solution in the solution supply apparatus into a solution storage tank at a speed of 10 mL/min; starting a cam motion mechanism to enable the wire mesh-type spinneret to reciprocate up and down at a constant speed of 5 cm/s; and opening the high-voltage electrostatic generator, adjusting the voltage to 60 kV, and forming a strong high-voltage electrostatic field between the wire mesh-type spinneret and the receiving electrode plate; where the wire mesh-type spinneret performs up-and-down reciprocating motion and repeatedly dips the spinning solution in the solution storage tank under the push of the cam mechanism, after the spinneret leaves the liquid level, the solution can form uniform liquid drops along each metal wire on the whole wire mesh plane due to the action of surface tension, when the metal wire moves to a specific height, the solution attached on the wire is stretched to form a Taylor cone so as to form a large quantity of fiber jet flow under the stretching action of a high-voltage electrostatic field, and the fiber jet flow is subjected to rotary whip, solvent volatilization, and solidification and deposition on the non-woven fabric under the action of electric field force to obtain the electrospinning nanofiber.

Through testing, the diameters of the electrospinning nanofiber prepared in Embodiments 1-3 are all 100-300 nm, while the diameters of the nanofiber obtained in the conventional technology are generally 300-800 nm, and compared with the conventional technology, the technical solution of the present invention significantly improves the diameter fineness and the diameter distribution uniformity of the nanofiber.

The embodiments in the specification are all described in a progressive manner, and each embodiment focuses on differences from other embodiments, and portions that are the same and similar between the embodiments may be referred to each other.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to these embodiments shown herein but is to be accorded the broadest scope consistent with the principles and novel features disclosed herein.

What is claimed is:

1. A cam-driven wire mesh-type electrospinning apparatus, comprising: a high-voltage (HV) power supply unit, a wire mesh-type spinneret, a fiber receiving device, a cam unit, and a solution supply unit; wherein
a first end of the wire mesh-type spinneret is connected to the HV power supply unit, and a second end of the wire mesh-type spinneret is connected to the cam unit; the wire mesh-type spinneret is installed on the solution supply unit; the fiber receiving device is positioned right above the wire mesh-type spinneret;
the wire mesh-type spinneret is formed by combining a plurality of metal wire arrays, and a quantity of metal wires is 2-16;
the wire mesh-type spinneret is one of a rectangular-welding ball wire mesh-type spinneret and a round-welding ball wire mesh-type spinneret, wherein the metal wires in the rectangular-welding ball wire mesh-type spinneret and the round-welding ball wire mesh-type spinneret comprise metal balls, each of the metal wires is made of at least one selected from the group consisting of copper, aluminum and iron, and a diameter of each of the metal wires is 1 mm-10 mm; a roughness Ra of each of the metal wires is 0.2-1.6; each of the metal balls is made of low-carbon steel metal, and a diameter of each of the metal balls is 1 mm-5 mm; and
an area of the wire mesh-type spinneret is 10 cm²-10000 cm².

2. The cam-driven wire mesh-type electrospinning apparatus according to claim 1, wherein the cam unit comprises a cam push rod and a cam; the cam push rod and the cam are made of polyoxymethylene or polytetrafluoroethylene; a cross section of the cam push rod is a rectangle, wherein a length of a short side of the rectangle is 2 mm-10 mm, and a length of a long side of the rectangle is 10 mm-100 mm; and the cam is a disc cam.

3. The cam-driven wire mesh-type electrospinning apparatus according to claim 2, wherein the HV power supply unit comprises a high-voltage electrostatic generator; the fiber receiving device comprises a receiving electrode plate, two receiving rollers, non-woven fabric, and a motor, wherein the non-woven fabric is flatly laid and wound on the two receiving rollers, the receiving electrode plate is positioned between upper non-woven fabric and lower non-woven fabric, a first end of a receiving roller of the two receiving rollers is connected to the motor, and a second end of the receiving roller is connected to a grounding electrode; and the solution supply unit comprises a solution storage tank, a peristaltic pump, and a solution supply apparatus.

4. The cam-driven wire mesh-type electrospinning apparatus according to claim 3, wherein the solution storage tank is made of polytetrafluoroethylene;
the receiving electrode plate is made of a conductive metal, and each of the two receiving rollers is made of a non-conductive insulating material; and
a diameter of each of the two receiving rollers is 20 mm-200 mm.

5. A use method for the cam-driven wire mesh-type electrospinning apparatus according to claim 1, comprising the following steps:
S1: adjusting a spinning distance between the wire mesh-type spinneret and the fiber receiving device, and adjusting a rotating speed of the fiber receiving device;
S2: filling a spinning solution into the solution supply unit;
S3: starting the cam unit to allow the wire mesh-type spinneret to reciprocate up and down for a regular motion; and
S4: starting the HV power supply unit, and adjusting a voltage to obtain electrospinning nanofiber.

6. The use method according to claim 5, wherein in step S1, the spinning distance is 10 cm-15 cm, and the rotating speed of the fiber receiving device is 100 r/min-1000 r/min.

7. The use method according to claim 6, wherein in step S2, the spinning solution is an aqueous solution of polyvinyl alcohol, and a mass fraction of the aqueous solution of polyvinyl alcohol is 8%-12%.

8. The use method according to claim 7, wherein in step S3, the regular motion is one selected from the group consisting of a constant velocity motion, a constant acceleration motion, a constant deceleration motion, and a simple harmonic motion.

9. The use method according to claim 5, wherein in step S4, the HV power supply unit generates direct current high-voltage electrostatic, and a voltage of the HV power supply unit is −2 kV to 60 kV.

10. The use method according to claim 5, wherein the cam unit comprises a cam push rod and a cam; the cam push rod and the cam are made of polyoxymethylene or polytetrafluoroethylene; a cross section of the cam push rod is a rectangle, wherein a length of a short side of the rectangle is 2 mm-10 mm, and a length of a long side of the rectangle is 10 mm-100 mm; and the cam is a disc cam.

11. The use method according to claim 10, wherein the HV power supply unit comprises a high-voltage electrostatic generator; the fiber receiving device comprises a receiving electrode plate, two receiving rollers, non-woven fabric, and a motor, wherein the non-woven fabric is flatly laid and wound on the two receiving rollers, the receiving electrode plate is positioned between upper non-woven fabric and lower non-woven fabric, a first end of a receiving roller of the two receiving rollers is connected to the motor, and a second end of the receiving roller is connected to a grounding electrode; and the solution supply unit comprises a solution storage tank, a peristaltic pump, and a solution supply apparatus.

12. The use method according to claim 11, wherein the solution storage tank is made of polytetrafluoroethylene;
the receiving electrode plate is made of a conductive metal, and each of the two receiving rollers is made of a non-conductive insulating material; and
a diameter of each of the two receiving rollers is 20 mm-200 mm.

13. The use method according to claim 6, wherein in step S4, the HV power supply unit generates direct current high-voltage electrostatic, and a voltage of the HV power supply unit is −2 kV to 60 kV.

14. The use method according to claim 7, wherein in step S4, the HV power supply unit generates direct current high-voltage electrostatic, and a voltage of the HV power supply unit is −2 kV to 60 kV.

15. The use method according to claim 8, wherein in step S4, the HV power supply unit generates direct current high-voltage electrostatic, and a voltage of the HV power supply unit is −2 kV to 60 kV.
